(19) United States
(12) Patent Application Publication
(10) Pub. No.: US 2021/0231859 A1
(43) Pub. Date: Jul. 29, 2021

(54) LIGHT GUIDE PLATE, OPTICAL MODULE AND ALL-TRANS DISPLAY DEVICE

(71) Applicant: BOE TECHNOLOGY GROUP CO., LTD., Beijing (CN)

(72) Inventors: Xinxing WANG, Beijing (CN); Zezhou YANG, Beijing (CN); Jikai YAO, Beijing (CN); Jaegeon YOU, Beijing (CN)

(21) Appl. No.: 16/301,493

(22) PCT Filed: Apr. 10, 2018
(86) PCT No.: PCT/CN2018/082507

§ 371 Date: Nov. 14, 2018

(30) Foreign Application Priority Data
May 11, 2017 (CN) 201710330500.5

(51) Int. Cl. F21V 8/00

(52) U.S. Cl. CPC G02B 6/0036; G02F 1/133524; G02B 6/0046; G02B 6/002

(57) ABSTRACT

The present disclosure relates to the field of display technology, and provides a light guide plate, an optical module, and an all-trans display device in embodiments. The light guide plate includes a light entrance surface, a light exit surface, a first surface opposite to the light exit surface, and a plurality of recessed structures on the first surface. Further, the plurality of recessed structures are configured such that at least light incident parallel to the light exit surface exits from the light guide plate at an angle of 60°-90° with respect to the light exit surface.

The present application is the U.S. national phase entry of PCT/CN2018/082507 filed on Apr. 10, 2018, which claims the benefit of

Chinese Patent Application No. 201710330500.5, filed on May 11, 2017, the entire disclosures of both are incorporated herein by reference.

### TECHNICAL FIELD

The present disclosure relates to the field of display technology, and in particular discloses a light guide plate, an optical module, and an all-trans display device.

### BACKGROUND

With the development of display technology and the rapid increase in demand for outdoor wearing of display devices, outdoor display technology is getting more and more attention.

All-trans display devices have attracted attention as a new type of display device. At night or at a dark brightness, the all-trans display device can realize display in combination with a front light guide plate and a light source. In contrast, in a case where the ambient light is sufficiently bright, the all-trans display device can realize display using only ambient light. In this way, power consumption of the all-trans display device is reduced to some extent.

However, typically, as shown in FIG. 1, most of light exiting from the light guide plate 10 and entering the display panel 30 is absorbed by a black matrix (BM) 31 in the display panel 30. Therefore, little light reaches the reflective area of the display panel 30 (i.e., the area not covered by the black matrix), so that high contrast display cannot be achieved.

### SUMMARY

According to an aspect of the present disclosure, a light guide plate is provided. Specifically, the light guide plate comprises: a light entrance surface; a light exit surface; a first surface opposite to the light exit surface; and a plurality of recessed structures formed on the first surface. Further, the plurality of recessed structures are configured such that at least light incident parallel to the light exit surface exits from the light guide plate at an angle of 60°-90° with respect to the light exit surface.

According to a specific implementation, in the light guide plate provided by an embodiment of the present disclosure, the light guide plate is shaped in a wedge, and each of the recessed structures has the same size and shape.

According to a specific implementation, in the light guide plate provided by an embodiment of the present disclosure, the plurality of recessed structures is shaped respectively in at least one of a prism, a pyramid, a hemisphere, and a semi-ellipsoid.

According to a specific implementation, in the light guide plate provided by an embodiment of the present disclosure, the light guide plate further comprises a second surface opposite to the light entrance surface, and the plurality of recessed structures are arranged in an array on the first surface. Further, along a direction from a first intersection line between the light entrance surface and the first surface to a second intersection line between the second surface and the first surface, the plurality of recessed structures increases gradually in density.

According to a specific implementation, in the light guide plate provided by an embodiment of the present disclosure, the plurality of recessed structures is shaped respectively in a prism. Specifically, the prism comprises a first bottom surface disposed close to the light exit surface, a second bottom surface opposite to the first bottom surface, as well as a reflective surface adjoining to the first bottom surface and the second bottom surface and reflecting light incident thereon.

According to a specific implementation, in the light guide plate provided by an embodiment of the present disclosure, a thickness of the prism is greater than 0 and less than or equal to 100 μm along a direction from the first bottom surface to the second bottom surface. Further, a length of the second bottom surface is greater than or equal to 1 mm and less than or equal to 10 mm along a direction from the first intersection line to the second intersection line. Further, an angle between the reflective surface and the light exit surface is greater than or equal to 30° and less than or equal to 60°.

According to another embodiment of the present disclosure, an optical module is also provided. Specifically, the optical module comprises: a light guide plate according to any of the preceding embodiments; and a light source disposed at the light entrance surface of the light guide plate.

According to a specific implementation, in the optical module provided by an embodiment of the present disclosure, the light source is configured to emit collimated light.

According to yet another embodiment of the present disclosure, an all-trans display device is also provided. Specifically, the all-trans display device comprises: a display panel; an optical module according to any of the preceding embodiments; and a scattering film disposed between the display panel and the optical module. Further, the light exit surface of the light guide plate is disposed close to a display surface of the display panel.

According to a specific implementation, the all-trans display device provided by an embodiment of the present disclosure further comprises: a first polarizer disposed between the display panel and the optical module. Specifically, the scattering film is integrated into the first polarizer, the first polarizer is bonded to the optical module by an adhesive layer, and a refractive index of the light guide plate is greater than a refractive index of the adhesive layer.

According to a specific implementation, in the all-trans display device provided by an embodiment of the present disclosure, the scattering film is disposed on a side of the display panel close to the light guide plate and is bonded to the light guide plate by an adhesive layer. Further, a refractive index of the light guide plate is greater than a refractive index of the adhesive layer.

According to a specific implementation, in the all-trans display device provided by an embodiment of the present disclosure, the scattering film is disposed on a side of the light guide plate close to the display panel and is bonded to the display panel by an adhesive layer. Likewise, a refractive index of the light guide plate is greater than a refractive index of the adhesive layer.

According to a specific implementation, in the all-trans display device provided by an embodiment of the present disclosure, the adhesive layer is made of an optical clear resin, and the light guide plate is made of PMMA or PC.

### BRIEF DESCRIPTION OF THE DRAWINGS

In order to more clearly illustrate the technical solutions in embodiments of the disclosure or in the prior art, the appended drawings needed to be used in the description of the embodiments or the prior art will be introduced briefly in the following. Obviously, the drawings in the following description are only some embodiments of the disclosure, and for those of ordinary skills in the art, other drawings can be obtained according to these drawings under the premise of not paying out creative work.

FIG. 1 is a light path diagram for light entering a display panel from a light guide plate according to a prior art;

FIG. 2 is a schematic structural view of a light guide plate according to an embodiment of the present disclosure;

FIG. 3 is a side view of a light guide plate according to an embodiment of the present disclosure;

FIG. 4 is a schematic structural view of a light guide plate according to another embodiment of the present disclosure;

FIG. 5 is a side view of a light guide plate according to another embodiment of the present disclosure;

FIG. 6 is a schematic structural view of a light guide plate according to yet another embodiment of the present disclosure;

FIG. 7 is a side view of a light guide plate according to yet another embodiment of the present disclosure;

FIG. 8A is a light path diagram for reflection of light parallel to a light exit surface on a recessed structure according to an embodiment of the present disclosure;

FIG. 8B is a light path diagram for reflection of light parallel to a light exit surface on a recessed structure according to another embodiment of the present disclosure;

FIG. 8C is a light path diagram for reflection of light parallel to a light exit surface on a recessed structure according to yet another embodiment of the present disclosure;

FIG. 9 is a light path diagram for light entering a display panel from a light guide plate according to an embodiment of the present disclosure;

FIG. 10A is a schematic simulation diagram of light exit from a light guide plate according to a prior art;

FIG. 10B is a schematic simulation diagram of light exit from a light guide plate according to an embodiment of the present disclosure;

FIG. 11 is an enlarged view of a recessed structure in FIG. 2;

FIG. 12 is a schematic structural view of an optical module according to an embodiment of the present disclosure;

FIG. 13 is a side view of an all-trans display device according to an embodiment of the present disclosure; and

FIG. 14 is a side view of an all-trans display device according to another embodiment of the present disclosure; and

FIG. 15 is a side view of an all-trans display device according to yet another embodiment of the present disclosure.

### DETAILED DESCRIPTION OF THE EMBODIMENTS

In the following, the technical solutions in the embodiments of the disclosure will be described clearly and completely in connection with the drawings in the embodiments of the disclosure. Obviously, the described embodiments are only part of the embodiments of the disclosure, and not all of the embodiments. Based on the embodiments in the disclosure, all other embodiments obtained by those of ordinary skills in the art under the premise of not paying out creative work pertain to the protection scope of the disclosure.

In the drawings and the following description, the following reference numerals are used to refer to various components as used herein: 10—light guide plate; 11—first surface; 12—second surface; 14—light exit surface; 15—light entrance surface; 16—recessed structures; 161—first bottom surface; 162—second bottom surface; 163—reflective surface; 20—light source; 30—display panel; 31—black matrix; 33—upper polarizer; 34—lower polarizer; 40—scattering film; and 50—adhesive layer.

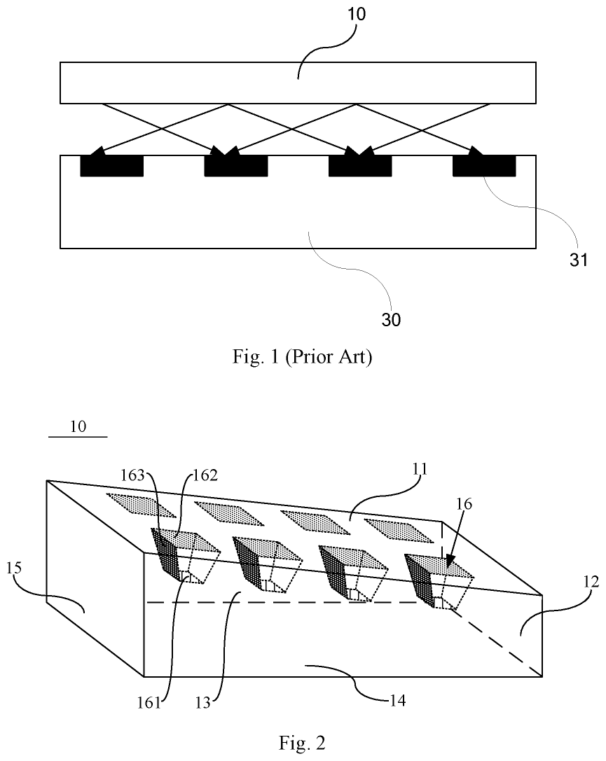

An embodiment of the present disclosure provides a light guide plate 10. As shown in FIGS. 2-7, the light guide plate 10 comprises a light entrance surface 15, a light exit surface 14, and a first surface 11 opposite to the light exit surface 14. In addition, the light guide plate 10 further comprises a plurality of recessed structures 16 disposed on the first surface 11. The plurality of recessed structures 16 are configured such that at least light incident parallel to the light exit surface 14 exits from the entire light guide plate 10 at an angle of 60°-90° with respect to the light exit surface 14.

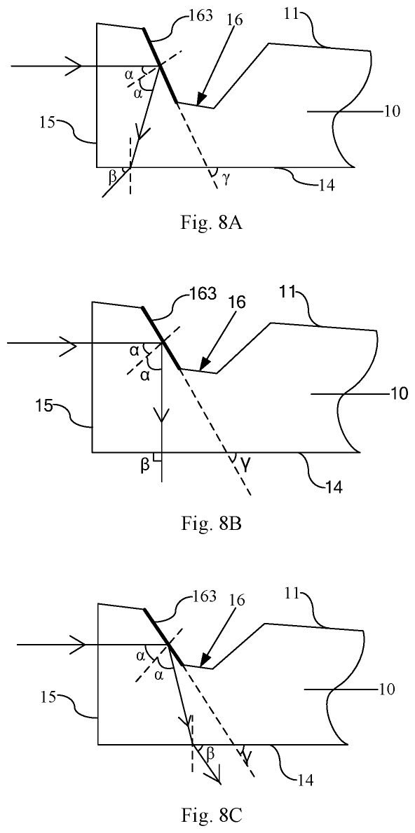

Here, as shown in FIGS. 8A-8C, if the light entrance surface 15 is perpendicular to the light exit surface 14, light incident parallel to the light exit surface 14 enters the light guide plate 10 and continues to travel in a straight line. When such light hits a point on the reflective surface 163 of the recessed structure 16, an angle between the light and the normal at the point is α, and reflection occurs thereon. After that, that is, after reflection on the reflective surface 163, the light exits at a β angle with respect to the light exit surface 14 after a further refraction at the light exit surface. Specifically, by adjusting the angle of the reflective surface 163 with respect to the light incident parallel to the light exit surface 14, the range of β is allowed to be 60°-90° when the light incident parallel to the light exit surface 14 exits from the light guide plate 10 through the light exit surface 14.

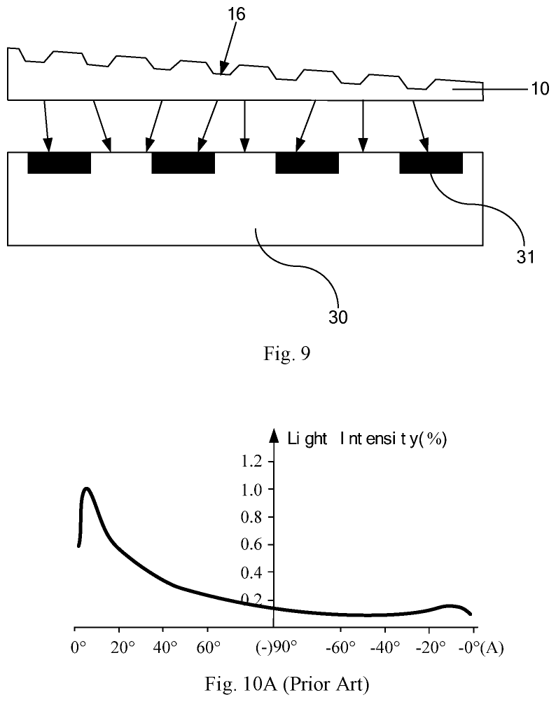

In view of this, as shown in FIG. 9, when an optical module, which is formed by the light guide plate 10 and a light source disposed at the light entrance surface 15 of the light guide plate 10, is applied to an all-trans display device, the light incident parallel to the light exit surface 14 enters the display panel 30 after exiting at an angle of 60°-90° with respect to the light exit surface 14. Specifically, the display panel 30 comprises a reflective area and a non-reflective area covered by the black matrix 31. After the light enters the reflective area of the display panel 30, it is reflected by a metal layer (e.g., a pixel electrode, a common electrode) in the reflective area, and then sequentially exit from the display panel 30 and the light guide plate 10, thereby realizing display.

In addition to the light parallel to the light exit surface 14, after entering the light guide plate 10 and being reflected by the recessed structure, other light may also exit at an angle of 60°-90° with respect to the light exit surface 14, so as to enter the light reflective area of the display panel 30 and be used for display.

It should be noted that the light guide plate 10 can be shaped in different shapes. For example, the light guide plate may be any of a wedge shape (as shown in FIGS. 2 and 6), a flat-plate shape (as shown in FIG. 4) and the like.

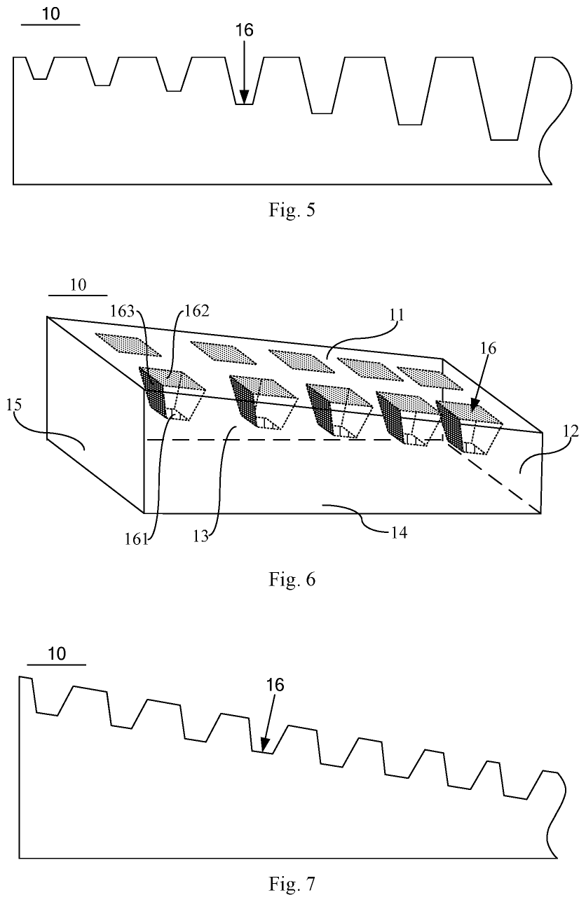

The light guide plate 10 further comprises a second surface 12 opposite to the light entrance surface 15. Specifically, as shown in FIG. 4 and FIG. 5, when the light guide plate 10 is a flat-plate shaped light guide plate, the thickness of the recessed structure 16 (i.e., the size in a direction perpendicular to the light exit surface 14) increases along a direction from a first intersection line between the light entrance surface 15 and the first surface 11 to a second intersection line between the second surface 12 and the first surface 11, such that light exits from the light guide plate 10 at various positions of the light exit surface 14.

Further, it should be noted that the material of the light guide plate 10 can also be flexibly selected according to actual needs, as long as the material of the light guide plate 10 does not affect the transmission of light. For example, the light guide plate 10 may be made of one of polyethyl methacrylate (PMMA), polycarbonate (PC), and glass.

In view of above, when the light guide plate 10 is applied to the all-trans display device, the refractive index of the light guide plate 10 should also be considered, so as to prevent the light exiting from the display panel 30 from being totally reflected after entering the light guide plate 10, thereby affecting the display.

In addition, it should be noted that any suitable shape for the recessed structure 16 may be selected, as long as after reflection by the reflective surface 163 of the recessed structure 16, the light incident parallel to the light exit surface 14 can exit at an angle of 60°-90° with respect to the light exit surface 14.

An embodiment of the present disclosure provides a light guide plate 10. In such a light guide plate 10, at least the light incident parallel to the light exit surface 14 of the light guide plate 10 exits from the entire light guide plate 10 at an angle of 60°-90° with respect to the light exit surface 14, after being reflected by the recessed structure 16 disposed on the first surface 11 of the light guide plate 10. In this way, when the optical module, which is formed by the light guide plate 10 and the light source disposed at the light entrance surface 15 of the light guide plate 10, is applied to the all-trans display device, the light enters the reflective area of the display panel 30 after exiting from the light exit surface 14 at an angle of 60°-90° with respect to the light exit surface 14. Further, such light can be used for display after being reflected by a metal layer (e.g., a pixel electrode, a common electrode) in the reflective area. Compared with the prior art, in an embodiment of the present disclosure, the amount of light incident on the reflective area is increased, thereby greatly improving the utilization of light, realizing high contrast display, and contributing to reduction of power consumption.

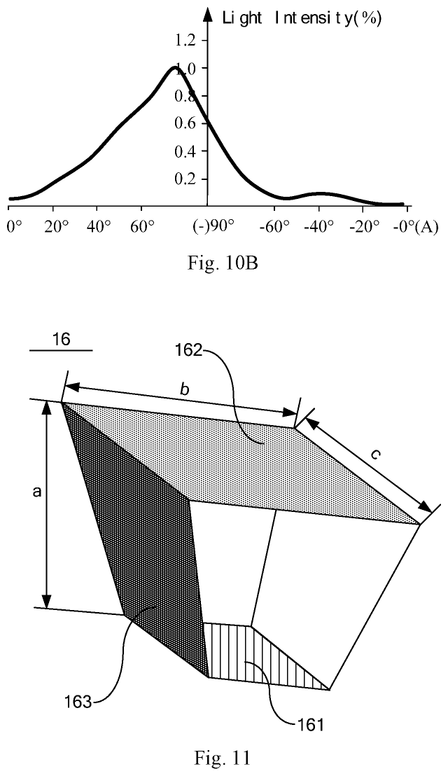

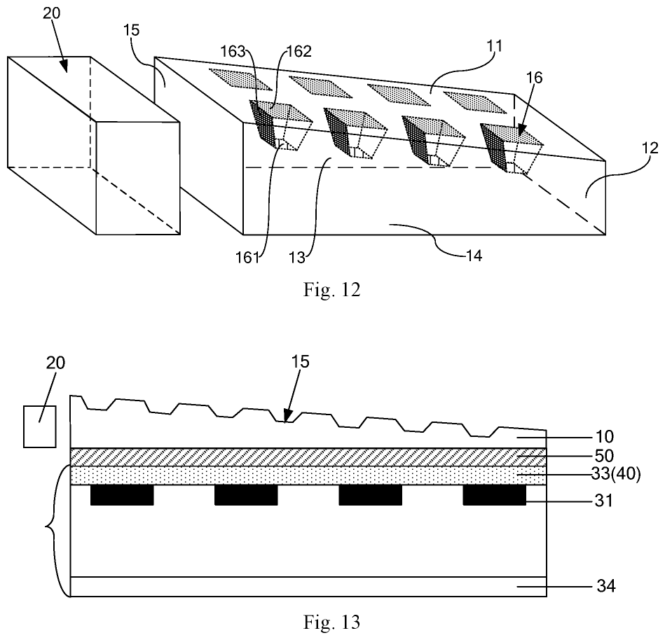

As shown in FIG. 10A, in the prior art, light incident parallel to the light exit surface 14 enters the light guide plate 10 at the position A, and when exiting from the light exit surface 14, the angle between the light having a large light intensity and the light exit surface 14 is very small. Therefore, as shown in FIG. 1, after entering the display panel 30, the light incident parallel to the light exit surface 14 is mostly absorbed by the black matrix 31, such that it cannot hit the reflective area of the display panel 30. As shown in FIG. 10B, in an embodiment of the present disclosure, light incident parallel to the light exit surface 14 enters the light guide plate 10 at the position A, and the light having a large light intensity exits from the light exit surface 14 at an angle of 60°-90°. Therefore, as shown in FIG. 9, after entering the display panel 30, the light incident parallel to the light exit surface 14 will mostly hit the reflective area of the display panel 30, and thereafter, it is reflected by a metal layer (e.g., a pixel electrode, a common electrode) in the reflective area, and then sequentially exits from the display panel 30 and the light guide plate 10, thereby realizing display.

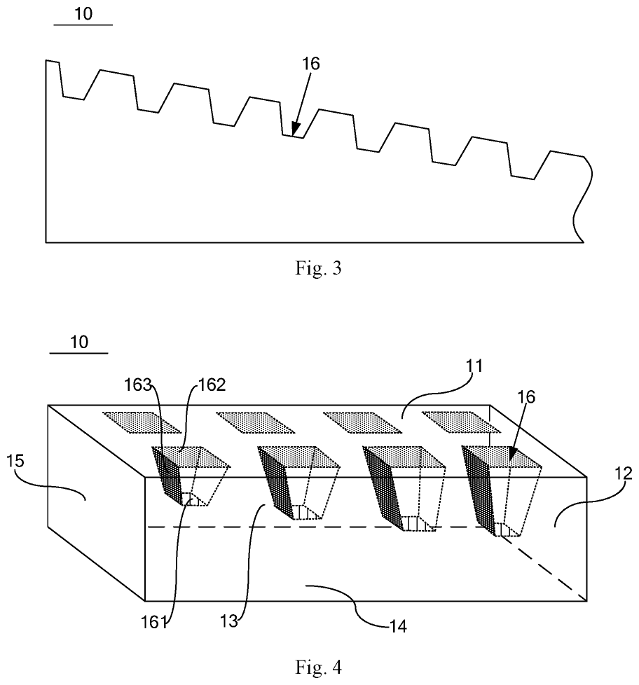

Optionally, as shown in FIGS. 2 and 3, as well as FIGS. 6 and 7, the shape of the light guide plate 10 is a wedge, and the size and shape of the recessed structures 16 are the same.

Herein, the recessed structures 16 are disposed on the first surface 11 and are recessed toward the light exit surface 14 in a recess shape. Therefore, considering the thickness of the light guide plate 10 and the recessed structures 16 in a direction perpendicular to the light exit surface 14, the degree of angle between the first surface 11 of the wedge-shaped light guide plate and the horizontal direction should be within a reasonable range. Optionally, the angle between the first surface 11 of the wedge-shaped light guide plate and the horizontal direction is greater than 0° and less than or equal to 10°.

As an example, the angle between the first surface 11 of the wedge-shaped light guide plate and the horizontal direction is 2°.

In an embodiment of the present disclosure, the recessed structures 16 are equal in size and shape, thereby facilitating simplification of the manufacturing process of the light guide plate 10.

Optionally, the plurality of recessed structures is shaped respectively in at least one of a prism, a pyramid, a hemisphere, and a semi-ellipsoid. This means that the plurality of recessed structures 16 may have identical shapes, i.e., one of a prism, a pyramid, a hemisphere, and a semi-ellipsoid; or alternatively, there may be recessed structures of different shapes.

In an embodiment of the present disclosure, since the shapes such as prism, pyramid, hemisphere, and semi-ellipsoid are common regular shapes, these shapes are easily formed in the process for manufacturing the recessed structures 16.

Optionally, as shown in FIGS. 6 and 7, the recessed structures 16 are arranged in an array on the first surface 11, and along a direction from the first intersection line between the light entrance surface 15 and the first surface 11 to the second intersection line between the second surface 12 and the first surface 11, the plurality of recessed structures increases gradually in density.

In an embodiment of the present disclosure, the recessed structures 16 are arranged in an array, since the array arrangement is relatively simple and easy to fabricate. On the basis of this, since the brightness decreases as the distance from the light entrance surface 15 increases, the density of the recessed structures 16 are selected to increase gradually along the direction from the first intersection line between the light entrance surface 15 and the first surface 11 to the second intersection line between the second surface 12 and the first surface 11, so that the light can be made uniform.

Optionally, as shown in FIG. 2, in a case where the shape of the recessed structures 16 is a prism, each of the recessed structures 16 comprises a first bottom surface 161 disposed close to the light exit surface 14, a second bottom surface 162 opposite to the first bottom surface 161, as well as a reflective surface 163 adjoining to the first bottom surface 161 and the second bottom surface 162 and reflecting light incident thereon

As shown in FIG. 2, FIG. 8A-8C, and FIG. 11, a thickness a of the recessed structure 16 in a direction from the first bottom surface to the second bottom surface is greater than 0 and less than or equal to 100 μm; along a direction from the first intersection line between the light entrance surface 15 and the first surface 11 to the second intersection line between the second surface 12 and the first surface 11, a length b of the second bottom surface 162 is greater than or equal to 1 mm and less than or equal to 10 mm; and an angle γ between the reflective surface 163 and the light exit surface 14 is greater than or equal to 30° and less than or equal to 60° (FIG. 11 is merely exemplified by a recessed structure in a wedge-shaped light guide plate).

Herein, the thickness a of the recessed structure 16 is determined by the thickness of the light guide plate 10 and the angle of light incident parallel to the light exit surface 14 when it exits from the light exit surface 14.

It should be noted that the prism may be a quadrangular prism, a pentagonal prism, a hexagonal prism, and the like. Optionally, the shape of the recessed structures 16 is a quadrangular prism.

As an example, the thickness a of the recessed structure 16 is 0.01 mm; along a direction from the first intersection line between the light entrance surface 15 and the first surface 11 to the second intersection line between the second surface 12 and the first surface 11, the length b of the second bottom surface 162 is 2.9 mm; and the angle γ between the reflective surface 163 and the light exit surface 14 is 45°.

In another embodiment, in a case where the shape of the light guide plate 10 is a flat-plate shape, along a direction from the first intersection line between the light entrance surface 15 and the first surface 11 to the second intersection line between the second surface 12 and the first surface 11, the thickness of the recessed structure 16 increases gradually, and at the same time, the length b and the width c of the second bottom surface 162, as well as the angle γ between the reflective surface 163 and the light exit surface 14 may also change with the increase of thickness. Of course, they may not change, as long as the length b is equal to or greater than 1 mm and less than or equal to 10 mm, the angle γ is equal to or greater than 30° and less than or equal to 60°, and the light incident parallel to the light exit surface 14 can exit at an angle of 60°-90° with respect to the light exit surface 14.

In an embodiment of the present disclosure, the prism may be used as the shape of the recessed structure 16, such that light incident parallel to the light exit surface 14 can exit at an angle of 60°-90° with respect to the light exit surface 14. In addition, since the reflective surface 163 of the prism has a large area, more light can be reflected. Further, by making the length b of the second bottom surface 162 greater than or equal to 1 mm and less than or equal to 10 mm, it can be ensured that all the light entering the light guide plate 10 parallel to the light exit surface 14 can hit the reflective surface 163 of the recessed structure 16, thereby improving the utilization of light. Further, by setting the angle γ between the reflective surface 163 and the light exit surface 14 to be greater than or equal to 30° and less than or equal to 60°, it can be ensured that the light incident parallel to the light exit surface 14 can exit at an angle of 60°-90° with respect to the light exit surface 14, thereby improving the utilization of light.

On the basis of this, considering that the recessed structures 16 are very small-sized microstructures during the actual manufacturing process, therefore, advantageously, along the extending direction of the first intersection line between the light entrance surface 15 and the first surface 11, the width c of the second bottom surface 162 is selected to be greater than 0 and less than or equal to 500 μm.

As an example, along the extending direction of the first intersection line between the light entrance surface 15 and the first surface 11, the width c of the second bottom surface 162 is 0.01 mm.

Embodiments of the present disclosure also provide an optical module. As shown in FIG. 11, the optical module comprises a light guide plate 10 according to any of the above embodiments; and a light source 20 disposed at the light entrance surface 15 of the light guide plate 10 (FIG. 11 merely take a wedge-shaped light guide plate as an example).

Herein, the light source 20 may be a light-emitting diode (LED) or a cold cathode fluorescent lamp (CCFL).

Embodiments of the present disclosure also provide an optical module. The optical module comprises a light guide plate 10 and a light source 20 disposed at the light entrance surface 15 of the light guide plate 10. Light emitted by the light source 20 enters the light guide plate 10 from the light entrance surface 15 of the light guide plate 10, and is reflected by recessed structures 16 on the first surface 11 of the light guide plate 10. After that, at least the light incident parallel to the light exit surface 14 of the light guide plate 10 exit at an angle of 60°-90° with respect to the light exit surface 14. When the optical module is applied to the all-trans display device, the light enters the reflective area of the display panel 30 after exiting from the light exit surface 14 at an angle of 60°-90° with respect to the light exit surface 14. After being reflected by the metal layer (e.g., the pixel electrode, the common electrode) in the reflective area, it can be used for display. Compared with the prior art, in an embodiment of the present disclosure, the amount of light incident on the reflective area is increased, thereby greatly improving the utilization of light, realizing high contrast display, and contributing to reduction of power consumption.

Optionally, the light source 20 is configured to emit collimated light.

In an embodiment of the present disclosure, at least the light incident parallel to the light exit surface 14 can exit at an angle of 60°-90° with respect to the light exit surface 14. Therefore, if the light emitted by the light source 20 is collimated light, the light exiting at an angle of 60°-90° with respect to the light exit surface 14 can be further increased. In this way, when the optical module is applied to the all-trans display device, the light entering the reflective area of the display panel 30 is increased, thereby further improving the contrast of the all-trans display device when in display.

Embodiments of the present disclosure also provide an all-trans display device. As shown in FIGS. 13-15, the all-trans display device comprises a display panel 30, an optical module according to any of the above embodiments, and a scattering film 40 disposed between the display panel 30 and the optical module. Further, the light exit surface 14 of the light guide plate 10 is disposed close to the display surface of the display panel 30.

Herein, the display panel 30 comprises a reflective area and a non-reflective area covered by the black matrix 31. After entering the reflective area of the display panel 30, the light is reflected by the metal layer (e.g., the pixel electrode, the common electrode) in the reflective area, and then sequentially exits from the display panel 30 and the light guide plate 10, thereby realizing display.

In an embodiment of the present disclosure, the light enters the reflective area of the display panel 30 and is reflected by the metal layer (e.g., the pixel electrode, the common electrode) in the reflective area, and then exits from the display panel 30 and passes through the light guide plate 10, thereby realizing display. In view of this, in order to make light exit directly from the light guide plate 10 without being reflected by the recessed structures 16 on the first surface 11 of the light guide plate 10 thereby affecting display, a scattering film 40 may be disposed between the display panel 30 and the optical module, making the light irreversible.

Optionally, as shown in FIG. 13, the all-trans display device further comprises a first polarizer disposed between the display panel 30 and the optical module, which is also referred to as an upper polarizer 33. Further, the scattering film 40 is integrated in the upper polarizer 33; the upper polarizer 33 is bonded to the optical module by an adhesive layer 50; and the refractive index of the light guide plate 10 is greater than the refractive index of the adhesive layer 50.

Herein, the display panel 30 further comprises an array substrate, a counter substrate, a liquid crystal layer disposed therebetween, and a lower polarizer 34 disposed on a side of the array substrate away from the counter substrate. Further, the array substrate may comprise a thin film transistor (TFT), a pixel electrode electrically connected to a drain of the TFT, and a common electrode. The counter substrate may comprise a black matrix 31 and a color film layer. Herein, the color film layer may be disposed on the counter substrate or on the array substrate. In addition, the common electrode may be disposed on the array substrate or on the counter substrate.

It should be noted that the adhesive layer 50 may be formed by any suitable material, as long as the adhesive layer 50 can bond the polarizer 33 and the optical module without affecting the transmission of light. For example, the adhesive layer 50 may be formed by a pressure sensitive adhesive (PSA), an optical clear resin (OCR), or the like.

In an embodiment of the present disclosure, by integrating the scattering film 40 into the upper polarizer 33, the thickness of the all-trans display device can be reduced, thereby facilitating the thin design of all-trans display device. In addition, by setting the refractive index of the light guide plate 10 to be larger than the refractive index of the adhesive layer 50, it is possible to prevent light from being totally reflected when entering the light guide plate 10 from the adhesive layer 50 rendering thereby that light can't exit from the light guide plate 10 and is thus unable to display.

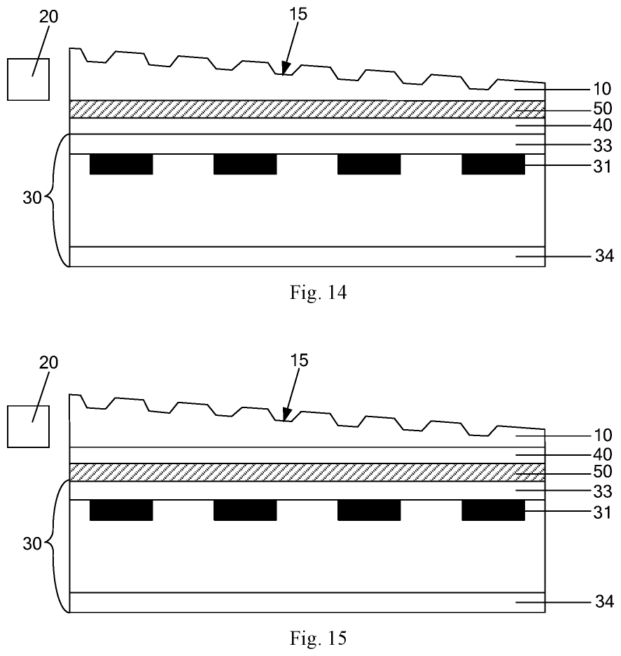

Optionally, as shown in FIG. 14, the scattering film 40 is disposed on a side of the display panel 30 close to the light guide plate 10, and is bonded to the light guide plate 10 by the adhesive layer 50. Alternatively, as shown in FIG. 15, the scattering film 40 may also be disposed on a side of the light guide plate 10 close to the display panel 30, and bonded to the display panel 30 by the adhesive layer 50. In either case, the refractive index of the light guide plate 10 is greater than the refractive index of the adhesive layer 50.

In an embodiment of the present disclosure, the scattering film 40 is disposed on a side of the display panel 30 close to the light guide plate 10, or the scattering film 40 is disposed on a side of the light guide plate 10 close to the display panel 30. In this way, a simple process is facilitated as compared with a case where the scattering film 40 is integrated in the upper polarizer 33. Further, by setting the refractive index of the light guide plate 10 to be larger than the refractive index of the adhesive layer 50, it is possible to prevent light from being totally reflected when entering the light guide plate 10 from the adhesive layer 50 rendering thereby that light can't exit from the light guide plate 10 and is thus unable to display.

Optionally, the adhesive layer 50 is made of OCR, and the light guide plate 10 is made of PMMA or PC.

In an embodiment of the present disclosure, an optical clear resin is a common adhesive material that not only has a bonding effect but also does not affect the transmission of light. A common material for the light guide plate 10 will be polyethyl methacrylate or polycarbonate, and its refractive index is larger than that of the optical clear resin, while still has a high transmittance.

The above embodiments are only used for explanations rather than limitations to the present disclosure, the ordinary skilled person in the related technical field, in the case of not departing from the spirit and scope of the present disclosure, may also make various modifications and variations, therefore, all the equivalent solutions also belong to the scope of the present disclosure, the patent protection scope of the present disclosure should be defined by the claims.

1. A light guide plate, comprising:
a light entrance surface;
a light exit surface;
a first surface opposite to the light exit surface; and
a plurality of recessed structures on the first surface, wherein the plurality of recessed structures are configured such that at least light incident parallel to the light exit surface exits from the light guide plate at an angle of 60°-90° with respect to the light exit surface.

2. The light guide plate according to claim 1, wherein
the light guide plate is shaped in a wedge, and
each recessed structure is the same in size and shape.

3. The light guide plate according to claim 1, wherein
the plurality of recessed structures are shaped respectively in at least one of a prism, a pyramid, a hemisphere and a semi-ellipsoid.

4. The light guide plate according to claim 1, wherein
the light guide plate further comprises a second surface opposite to the light entrance surface, and
the plurality of recessed structures are arranged in an array on the first surface, wherein
along a direction from a first intersection line between the light entrance surface and the first surface to a second intersection line between the second surface and the first surface, the plurality of recessed structures increases gradually in density.

5. The light guide plate according to claim 4, wherein
the plurality of recessed structures are shaped respectively in a prism, and
the prism comprises a first bottom surface close to the light exit surface, a second bottom surface opposite to the first bottom surface, as well as a reflective surface adjoining to the first bottom surface and the second bottom surface and reflecting light incident thereon.

6. The light guide plate according to claim 5, wherein
a thickness of the prism is greater than 0 and less than or equal to 100 μm along a direction from the first bottom surface to the second bottom surface,
a length of the second bottom surface is greater than or equal to 1 mm and less than or equal to 10 mm along a direction from the first intersection line to the second intersection line, and
an angle between the reflective surface and the light exit surface is greater than or equal to 30° and less than or equal to 60°.

7. An optical module, comprising:
the light guide plate according to claim 1;
a light source at the light entrance surface of the light guide plate.

8. The optical module according to claim 7, wherein:
the light source is configured to emit collimated light.

9. An all-trans display device, comprising:
a display panel;
the optical module according to claim 7;
a scattering film between the display panel and the optical module, wherein
the light exit surface of the light guide plate is disposed close to a display surface of the display panel.

10. The all-trans display device according to claim 9, further comprising:
a first polarizer between the display panel and the optical module, wherein
the scattering film is integrated into the first polarizer,
the first polarizer is bonded to the optical module by an adhesive layer, and
a refractive index of the light guide plate is greater than a refractive index of the adhesive layer.

11. The all-trans display device according to claim 9, wherein
the scattering film is located on a side of the display panel close to the light guide plate, and bonded to the light guide plate by an adhesive layer, wherein a refractive index of the light guide plate is greater than a refractive index of the adhesive layer.

12. The all-trans display device according to claim 9, wherein
the scattering film is located on a side of the light guide plate close to the display panel, and bonded to the display panel by an adhesive layer, wherein a refractive index of the light guide plate is greater than a refractive index of the adhesive layer.

13. The all-trans display device according to claim 10, wherein
the adhesive layer is made of an optical clear resin, and
the light guide plate is made of PMMA or PC.

14. The light guide plate according to claim 2, wherein
the plurality of recessed structures are shaped respectively in at least one of a prism, a pyramid, a hemisphere and a semi-ellipsoid.

15. The light guide plate according to claim 2, wherein
the light guide plate further comprises a second surface opposite to the light entrance surface, and
the plurality of recessed structures are arranged in an array on the first surface, wherein
along a direction from a first intersection line between the light entrance surface and the first surface to a second intersection line between the second surface and the first surface, the plurality of recessed structures increases gradually in density.

16. The all-trans display device according to claim 11, wherein
the adhesive layer is made of an optical clear resin, and
the light guide plate is made of PMMA or PC.

17. The all-trans display device according to claim 12, wherein
the adhesive layer is made of an optical clear resin, and
the light guide plate is made of PMMA or PC.
